(19) United States
(12) Patent Application Publication
(10) Pub. No.: US 2003/0034245 A1
(43) Pub. Date: Feb. 20, 2003

(54) Sensor element

(76) Inventor: Lothar Diehl, Stuttgart (DE)

Correspondence Address: KENYON & KENYON, ONE BROADWAY, NEW YORK, NY, 10004, US

(21) Appl. No.: 10/140,903

(22) Filed: May 7, 2002

(30) Foreign Application Priority Data
May 8, 2001 (DE) 101 22 271.8

(51) Int. Cl. G01N 27/407; B29B 13/00

(52) U.S. Cl. 204/424; 204/429; 264/44

(57) ABSTRACT

A sensor element containing a porous layer is provided for detecting a physical magnitude of a measured gas, such as for determining the concentration of a gas component of an exhaust gas of an internal combustion engine. The porous layer includes pores of a first pore type whose diameters correspond to at least half the layer thickness of the porous layer.

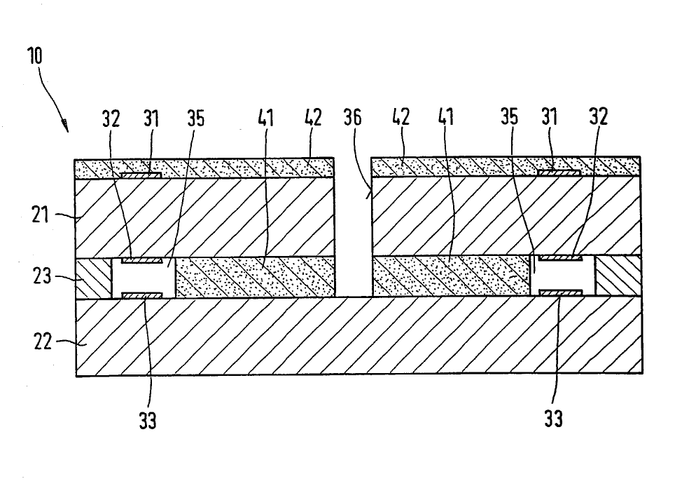

### FIELD OF THE INVENTION

The present invention relates to a sensor element.

### BACKGROUND INFORMATION

A sensor element is discussed, for example, in German Published Patent Application No. 198 57 471. The sensor element contains a porous layer that is used as a diffusion barrier and an additional porous layer that covers an external pump electrode. To manufacture the porous layers using a screen printing method, a paste containing a finely distributed powdery pore-forming material may be applied onto a ceramic element (green foil (film)). Subsequently, the paste is heated to a temperature at which the pore-forming material volatilizes almost without residue, leaving pores. Theobromine may, for example, be used as a pore-forming material.

Porous layers may have varying thicknesses, due, for example, to non-uniform application of the paste in the screen printing method, or due to a squeezing of the paste during a lamination process. If, for example, the thickness of a porous layer used as a diffusion barrier deviates from the target value, the diffusion current through the diffusion barrier may change, and the measurement result of the sensor element may thus change, so that expensive methods for the correction of this effect become necessary.

### SUMMARY OF THE INVENTION

It is believed that an exemplary sensor element according to the present invention has the advantage that a porous layer situated in the sensor element has a uniform thickness, with a production variance that is negligibly small.

For this purpose, the porous layer has pores whose diameters correspond approximately to the thickness of the porous layer. The porous layer is manufactured by application of a paste onto a substrate, the paste containing a finely distributed powdery pore-forming material that volatilizes almost without residue during the sintering process. The pore-forming material has particles, the diameters of which correspond approximately to the layer thickness of the paste. In this manner, the paste may be applied in a more uniform fashion, so that a uniform layer thickness may be ensured or at least be more likely, independent of the conditions during the printing method. Moreover, the paste may not be squeezed, for example, by the lamination process.

If the porous layer has pores of a first type, the diameters of which correspond approximately to the thickness of the porous layer, and pores of a second type, the diameters of which are approximately 10 to 80 percent, for example, 20 to 50 percent, of the diameter of the pores of the first type, it the diffusion current through the diffusion barrier is easily adjustable and is sufficiently limited. A particularly reliable reduction of the scattering of the thickness of the porous layer is achieved in that the diameters of the pores of the first type are at most 20 percent, for example, at most 10 percent, smaller than the thickness of the porous layer.

In an exemplary embodiment according to the present invention, the portion of pores of the first type in the porous layer is approximately 3 to 10 volume percent, and the portion of the pores of the second type in the porous layer is approximately 10 to 50 volume percent.

An exemplary method for manufacturing a sensor element according to the present invention permits a manufacturing of the porous layers having a negligibly small manufacturing fluctuation with respect to the thickness of the porous layers.

### BRIEF DESCRIPTION OF THE DRAWING

The FIGURE shows a cross-section of detail of an exemplary sensor element according to the present invention.

### DETAILED DESCRIPTION

The FIGURE shows a schematic representation of a section through an exemplary sensor element 10 according to the present invention that may be manufactured using ceramic foil technology and screen printing technology. Sensor element 10, shown in the FIGURE, is a broadband lambda sensor, having a pump cell that operates according to the limiting current principle, and having a measurement cell (Nernst cell). In addition, the sensor element has an integrated resistance heating unit (not shown). However, this design does not limit the invention to the exemplary embodiment shown in the FIGURE. The invention is likewise applicable to other sensor elements having porous layers.

The sensor element, which is shown only in detail in the FIGURE, contains four or five solid electrolyte layers that are laminated together, of which only a first solid electrolyte layer 21 and a second solid electrolyte layer 22 are shown.

On first solid electrolyte layer 21, a first electrode 31 (outer pump electrode) and a second electrode 32 (inner pump electrode) are situated on an external surface of sensor element 10. A porous protective layer 42 is situated over first electrode 31. Second electrode 32 is of annular construction, and is situated in a measured gas chamber 35 in which a third electrode 33 (measurement electrode) is situated opposite second electrode 32, on second solid electrolyte layer 22. Measured gas chamber 35 is sealed laterally by a sealing frame 23, which may be made, for example, of a solid electrolyte. First and second electrode 31, 32 together form the pump cell. Third electrode 33 operates together with a fourth electrode reference electrode (not shown), which is situated in a reference gas chamber (not shown), which may be connected, for example, with the air as a reference atmosphere.

In the layer plane between first and second solid electrolyte layers 21, 22, a diffusion channel extends, in which a porous diffusion barrier 41 is situated. Diffusion barrier 41 is placed in annular fashion around a gas inlet opening 36 in first solid electrolyte layer 21. The measured gas, situated outside sensor element 10, may flow to second and third electrodes 32, 33, situated in measured gas chamber 35, through gas inlet opening 36 and diffusion barrier 41.

For the manufacturing of the exemplary sensor element 10 according to the present invention, ceramic foils are used that are made of a solid electrolyte that conducts oxygen ions, for example, zirconium dioxide stabilized with Y₂O₃. The solid electrolyte foils may be printed with the electrodes and the associated printed conductors, as well as with additional functional layers, for example, using the screen printing technique, and, after the sintering, form solid electrolyte layers 21, 22. The electrodes and the printed conductors may be made of a platinum cermet.

On first solid electrolyte foil 21, for example, first electrode 31 and pastes forming porous protective layer 42 may be printed. On the side opposite first electrode 31 of first solid electrolyte layer 21, pastes are printed that form second electrode 32, diffusion barrier 41, measured gas chamber 35, third electrode 33, and sealing frame 23. The pastes for measured gas chamber 35, and, if necessary, gas inlet opening 36, are cavity pastes, which may be made, for example, of glassy coal, which burns out or vaporizes during the later sintering process, forming hollow spaces 35, 36 between first and second solid electrolyte foils 21, 22. The finally printed solid electrolyte foils are laminated together and sintered.

To produce the pores in the porous layers, for example, diffusion barrier 41 and protective layer 42, a paste is used that contains a ceramic powder and a pore-forming powder. The finely distributed particles of the pore-forming powder burn out during the sintering, thus producing an open porosity. The paste that forms porous layer 41, 42 contains pore-forming material of a first and of a second pore type. The pore-forming material of the first pore type is selected such that the diameter of the particles of the pore-forming powder of the first pore type correspond approximately to the layer thickness of the ceramic paste that is applied onto the solid electrolyte foil and that forms the porous layer. The diameter of the particles of the pore-forming powder of the second pore type is from approximately 20 to 50 percent of the diameter of the particles of the pore-forming powder of the first pore type. In an alternative exemplary embodiment according to the present invention, at least approximately 90 percent of the pores of the second type are smaller than approximately 80 percent of the diameter of the pores of the first type, that is, d₉₀ of the pores of the second type is smaller than approximately 80 percent of the diameter of the pores of the first type.

In the exemplary embodiment shown in the FIGURE, the distance of the first second solid electrolyte layer from the second solid electrolyte layer is 20 μm. The diameter of the particles of the pore-forming material of the first pore type is selected at approximately 20 to 22 μm, and the diameter of the particles of the pore-forming material of the second pore type is selected at approximately 2 to 10 μm. After the sintering process, due to the sintering shrinkage the diameter of the pores of the first type in diffusion barrier 41 is in the range from approximately 18 to 20 μm, and the diameter of the pores of the second type is from approximately 2.2 to 9 μm. The d₉₀ of the pores of the second type is approximately 8 μm, so that approximately 90 percent of the pores of the second type have a diameter less than or equal to approximately 8 μm. The diameter of a pore of the first or of the second type is the extension of a pore in the direction perpendicular to the plane of the porous layer. The portion of the pores of the first type in diffusion barrier 41 is approximately 5 percent by volume, and the portion of the pores of the second type is approximately 20 percent by volume.

What is claimed is:

1. A sensor element for detecting a physical magnitude of a measured gas, the sensor element comprising:
a porous layer that includes pores of a first pore type having diameters that correspond to at least half a layer thickness of the porous layer.

2. The sensor element of claim 1, wherein the diameters of the pores of the first pore type are at most 20 percent less than the layer thickness of the porous layer.

3. The sensor element of claim 1, wherein the porous layer includes pores of a second pore type, diameters of at least approximately 90 percent of the pores of the second pore type being less than approximately 10 to 80 percent of the diameters of the pores of the first pore type.

4. The sensor element of claim 1, wherein the porous layer includes pores of a second pore type having diameters in the range from approximately 10 to 80 percent of the diameters of the pores of the first pore type.

5. The sensor element of claim 1, wherein the porous layer includes pores of a second pore type having diameters that are less than approximately 70 percent of the layer thickness of the porous layer.

6. The sensor element of claim 1, wherein the diameters of the pores of the first pore type are in a range from approximately 5 to 50 μm.

7. The sensor element of claim 1, wherein a portion of the pores of the first pore type in the porous layer is approximately 3 to 10 percent by volume.

8. The sensor element of claim 4, wherein a portion of the pores of the second pore type in the porous layer is approximately 10 to 50 percent by volume.

9. The sensor element of claim 1, wherein the porous layer includes a diffusion barrier situated between a first and a second solid electrolyte layer, and the diameters of the pores of the first pore type are at most 20 percent less than a distance between the first solid electrolyte layer and the second solid electrolyte layer in a region of the diffusion barrier.

10. The sensor element of claim 9, wherein the diffusion barrier is situated between a measured gas chamber inserted in the sensor element and a gas inlet opening, and the measured gas chamber is provided between the first and the second solid electrolyte layer, and at least one electrode is positioned in the measured gas chamber on at least one of the first and second solid electrolyte layer.

11. The sensor element of claim 1, wherein the porous layer includes a protective layer deposited on a solid electrolyte layer.

12. The sensor element of claim 11, wherein at least one electrode is provided between the protective layer and the solid electrolyte layer.

13. A method for manufacturing a sensor element that is operable to detect a physical magnitude of a measured gas, the method comprising:
producing a porous layer by printing a paste onto a carrier and sintering the paste, wherein:
the paste includes a ceramic powder and a pore-forming powder,
the pore-forming powder volatilizing substantially without residue during the sintering and leaving pores, and
the pore-forming powder provides particles of a first pore type having diameters that correspond to at least half a layer thickness of the paste printed onto the carrier.

14. The method of claim 13, wherein the diameters of the particles of the first pore type are at most 20 percent less than the layer thickness of the paste printed onto the carrier.

15. The method of claim 13, wherein the pore-forming powder includes particles of a second pore type having diameters that are approximately 10 to 80 percent of the diameters of the particles of the pore-forming powder of the first pore type.

16. The method of claim 13, wherein a portion of the pore-forming powder of the first pore type is approximately 3 to 10 percent by volume in relation to the paste forming the porous layer.

17. The method of claim 13, wherein a portion of the pore-forming powder of the second pore type is approximately 10 to 50 percent by volume in relation to the paste forming the porous layer.

18. The sensor element of claim 1, wherein the sensor element is used for determining a concentration of a gas component of an exhaust gas of an internal combustion engine.

19. The sensor element of claim 2, wherein the diameters of the pores of the first pore type are at most 10 percent less than the layer thickness of the porous layer.

20. The sensor element of claim 3, wherein the diameters of the at least approximately 90 percent of the pores of the second pore type are less than approximately 20 to 50 percent of the diameters of the pores of the first pore type.

21. The sensor element of claim 4, wherein the pores of the second pore type have diameters in the range from approximately 20 to 50 percent of the diameters of the pores of the first pore type.

22. The sensor element of claim 6, wherein the diameters of the pores of the first pore type are approximately 20 μm.

23. The sensor element of claim 7, wherein the portion of the pores of the first pore type in the porous layer is approximately 5 percent by volume.

24. The sensor element of claim 8, wherein the portion of the pores of the second pore type in the porous layer is approximately 20 percent by volume.

25. The sensor element of claim 9, wherein the diameters of the pores of the first pore type are at most 10 percent less than the distance between the first solid electrolyte layer and the second solid electrolyte layer in the region of the diffusion barrier.

26. The sensor element of claim 11, wherein the protective layer is deposited on an external surface of the sensor element.

27. The method of claim 14, wherein the diameters of the particles of the first pore type are at most 10 percent less than the layer thickness of the paste printed onto the carrier.

28. The method of claim 15, wherein the diameters of the particles of the second pore type are approximately 20 to 50 percent of the diameters of the particles of the pore-forming powder of the first pore type.

29. The method of claim 16, wherein the portion of the pore-forming powder of the first pore type is approximately 5 percent by volume in relation to the paste forming the porous layer.

30. The method of claim 17, wherein the portion of the pore-forming powder of the second pore type is approximately 20 percent by volume in relation to the paste forming the porous layer.
